(19) United States
(12) Patent Application Publication
(10) Pub. No.: US 2002/0154062 A1
(43) Pub. Date: Oct. 24, 2002

(54) Antenna device

(76) Inventors: Masaaki Abe, Urawa-City, Saitama (JP); Makoto Fujita, Yokohama-City, Kanagawa (JP)

Correspondence Address: Corporate Patent Counsel, Philips Electronics North America Corporation, 580 White Plains Road, Tarrytown, NY, 10591, US

(21) Appl. No.: 10/111,546

(22) PCT Filed: Aug. 28, 2001
(86) PCT No.: PCT/EP01/09996

(30) Foreign Application Priority Data
Aug. 30, 2000 (JP) 2000-260096

(51) Int. Cl. H01Q 1/24; H01Q 1/40

(52) U.S. Cl. 343/700 MS; 343/702; 343/873

(57) ABSTRACT

The invention provides an antenna device 1 that is small in its size but wide in its bandwidth. The recess 2a is formed in the dielectric substrate 2. The shorting electrode 5 is formed on the front surface 2d of the substrate 2 for connecting radiation electrode 3 to each of grounding electrodes 6, 7.

### TECHNICAL FIELD

The invention relates to an antenna device comprising a radiation electrode that extends two-dimensionally. The invention further relates to a printed circuit board and to a mobile radio apparatus

### BACKGROUND OF THE INVENTION

As mobile communication equipments such as mobile radio apparatus, e.g. telephones have been commonly used, their size needs to be made smaller. In recent years, in order to meet this requirement, chip type antennas, for example, have been developed for the mobile communication equipments.

Since a chip antenna can be rather small in comparison with a monopole type antenna, the mobile communication equipment itself can be also made smaller by use of the chip antenna. On the other hand, however, there exists a problem that the bandwidth of the chip antenna may become narrow due to the small size of the antenna.

Accordingly, it is an object of the invention to provide an antenna device that is small in its size but wide in its bandwidth.

### SUMMARY OF THE INVENTION

In order to achieve the above-described object, the invention provides an antenna device comprising a substrate and a radiation electrode which extends two-dimensionally and is formed on a surface of or inside the substrate wherein the substrate has a hollow part or a recess.

The hollow part or recess formed in the substrate provides an effect of widening the bandwidth of the antenna device.

Especially, the substrate for the antenna device in accordance with the invention preferably contains a dielectric material or a magnetic material. Either dielectric material or magnetic material may be used as a material for the substrate depending on the applications. In particular, the dielectric material can provide an antenna that has a favorable high frequency characteristic.

Besides, the antenna device in accordance with the invention is preferably constructed in such manner that a recess extending from a front surface to a rear surface of the substrate is formed in a lower surface of the substrate, first and second grounding electrodes are formed respectively on both sides of that portion of the lower surface of the substrate where the recess is formed, and an shorting electrode is formed on one of the front surface and the rear surface of the substrate for connecting the radiation electrode to each of the first and second grounding electrodes.

With the shorting electrode as formed above, the bandwidth of the antenna device can be further widened.

### BRIEF DESCRIPTION OF THE DRAWINGS

FIG. 1 is a front-side perspective of an antenna device in accordance with one embodiment of the invention;

FIG. 2 is a rear-side perspective of the antenna device shown in FIG. 1;

FIG. 3 is a rear-side perspective of the same antenna device being placed upside-down;

FIG. 4 is a perspective of a conventional antenna device; and

FIG. 5 is a graph for showing the comparison of frequency characteristics between an antenna device 1 of an embodiment of the invention and a conventional antenna device 100.

### DETAILED DESCRIPTION OF THE INVENTION

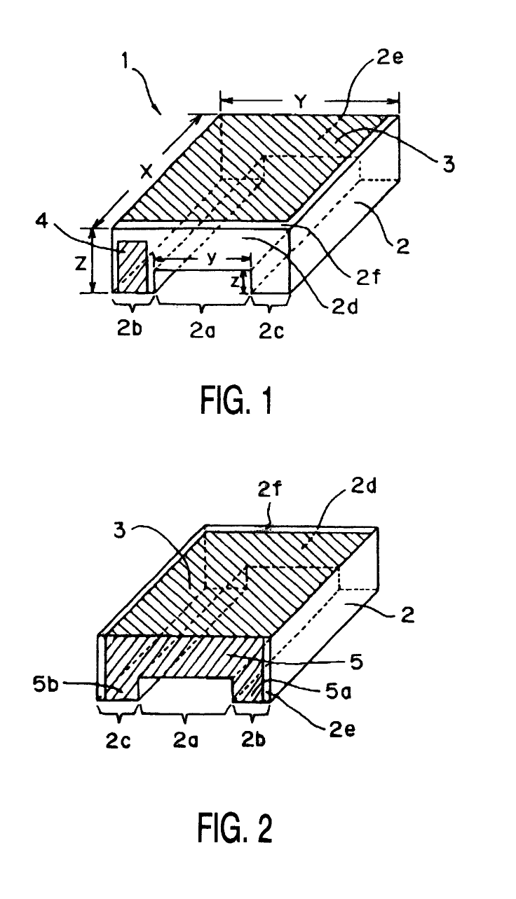

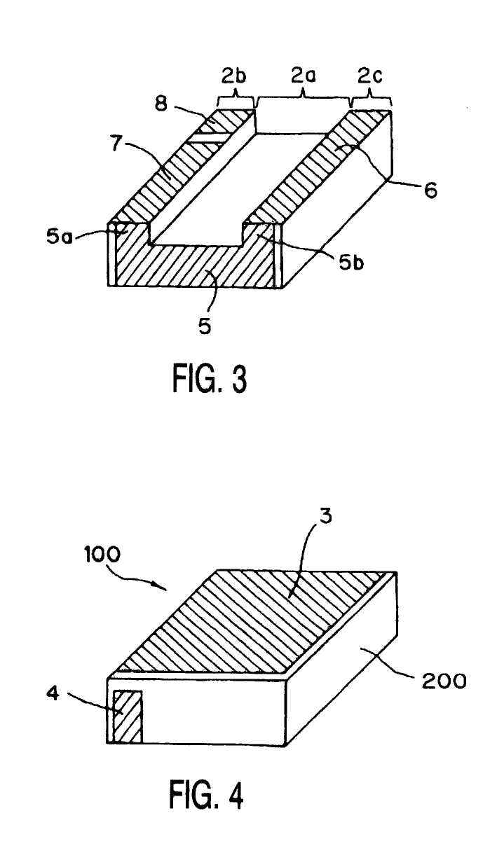

FIG. 1 is a front-side perspective view of an antenna device in accordance with one embodiment of the invention, FIG. 2 is a rear-side perspective view of the antenna device shown in FIG. 1, and FIG. 3 is a rear-side perspective view of the same antenna device being placed upside-down.

The antenna device 1, as shown in FIG. 1, comprises a dielectric substrate 2 that mainly contains such a dielectric material as ceramic. In a lower surface of this dielectric substrate, a recess 2a is formed which extends from a front surface 2d to a rear surface 2e of the dielectric substrate (see FIG. 3), so that projections 2b and 2c projecting relative to the recess 2a are formed on both sides of the recess 2a.

Besides, a radiation electrode 3 in a rectangle shape is formed on the upper surface 2f of the dielectric substrate 2. Furthermore, as shown in FIG. 3, a grounding electrode 6 is formed on a lower-surface of one projection 2c, and another grounding electrode 7 and a lower-surface feeding electrode 8 are formed in a lower surface of the other projection 2b. The grounding electrode 7 and the lower-surface feeding electrode 8 are located separately each other. Besides, a front-surface feeding electrode 4 is formed on the projection 2b side of the front surface 2d as shown in FIG. 1. This front-surface feeding electrode 4 is connected to the lower-surface feeding electrode 8 shown in FIG. 3. Yet, a shorting electrode, which is connected to the radiation electrode 3, is formed on the rear surface 2e of the dielectric substrate 2 as shown in FIG. 2. This shorting electrode extends from the projection 2b side to the projection 2c side within the rear surface 2e of the dielectric substrate 2. One end portion 5a on the projection 2b side of the shorting electrode 5 is connected to the grounding electrode 7 and the other end portion 5b on the projection 2c side of the shorting electrode 5 is connected to the grounding electrode 6 (see FIG. 3).

Such constructed antenna device 7 is a chip type antenna device that has been constructed by forming electrodes 3, 4, 5, 6, 7 and 8 on the dielectric substrate 2. With such chip type structure, the size of the antenna device 1 could be reduced.

Moreover, in this antenna device 1, the recess 2a is formed in the dielectric substrate 2. This recess 2a contributes to widening the bandwidth of the antenna device 1. Besides, in this embodiment, the shorting electrode is connected to both of the grounding electrodes 6 and 7 rather than only one of those two grounding electrodes 6 and 7. The frequency bandwidth can be further widened by providing with such structure of connection to both of the two grounding electrodes 6 and 7 in comparison with the structure of connection to only one of the two grounding electrodes 6 and 7. However, as long as a desired frequency bandwidth can be obtained, the structure of connection of the shorting electrode 5 to only one of the two grounding electrodes 6 and 7 may be allowed.

In this embodiment, the antenna device 1 is provided with the dielectric substrate 2 that mainly contains the ceramic material. However, it should be noted that the antenna device 1 may be provided with a magnetic substrate that mainly contains a magnetic material (for example, a ferrite material) instead of the dielectric substrate 2. In the case of providing the antenna device 1 with the magnetic substrate instead of dielectric substrate 2, it is possible to widen the frequency bandwidth of the antenna device by forming a recess (groove) in the magnetic substrate.

Furthermore, in this embodiment, the recess 2a of the dielectric substrate 2 is formed so as to extend from the front surface 2d to the rear surface 2e. However, there is no need to form the recess 2a in the shape of extending from the front surface 2d to the rear surface 2e, and the shape of the recess 2a may vary depending on the usage of the antenna device 1. Besides, although this embodiment provides the recess 2a in the dielectric substrate 2 in order to widen the frequency bandwidth, a hollow part may be alternatively used rather than the recess. The hollow part can equivalently serve to widen the frequency bandwidth of the antenna device 1.

It should be also noted that the invention should not be limited to the aforementioned embodiment and that various changes to the aforementioned embodiment may be possible.

One embodiment example of the antenna device according to the present invention is explained below. In this embodiment example, the antenna device 1 having the structure shown in FIG. 1 is used. The permittivity ε of the dielectric substrate 2 of the antenna device 1 in this embodiment example is approximately equal to 20. As for the dimension of the antenna device 1, the length X, width Y and height Z of the dielectric substrate 2 shown in FIG. 1 are 9 mm, 6 mm and 2 mm respectively, and the width y and depth z of the recess 2a are 4 mm and 1 mm respectively (the length of the recess 2a is 9 mm, which is equal to the length X of the dielectric substrate 2). FIG. 4 illustrates an antenna device 100 as an example for comparison. The differences between the antenna device 1 as the embodiment example and the antenna device 100 as the comparison example are that the dielectric substrate 2 of the antenna device 1 as the embodiment example comprises the recess 2a whereas the dielectric substrate 200 of the antenna device 100 as the comparison example does not comprise such recess but is formed in a rectangular solid, and that a grounding electrode for the antenna device 100 as the comparison example is formed almost all over the lower surface of the dielectric substrate 200.

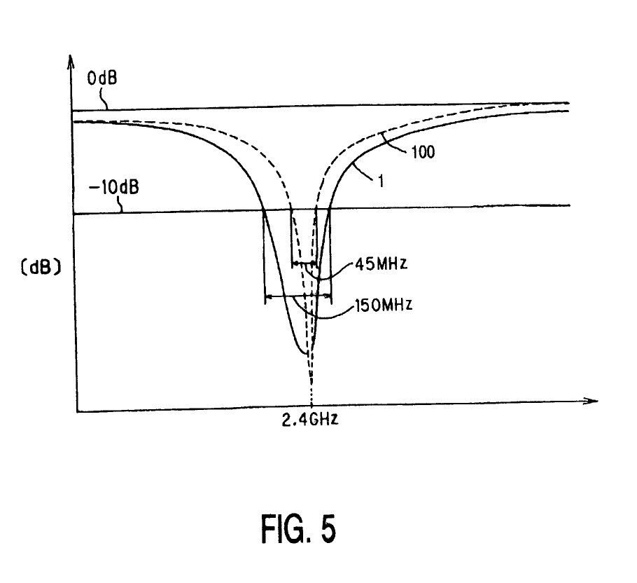

FIG. 5 shows frequency characteristics of the antenna device 1 as the embodiment example and the antenna device 100 as the comparison example. The solid line represents the frequency characteristic of the antenna device 1 as the embodiment example and the broken line represents the frequency characteristic of the antenna device 100 as the comparison example. As seen in FIG. 5, both center frequencies for the embodiment example and the comparison example lie in 2.4 GHz. However, on the −10 dB line, the bandwidth of the antenna device 100 as the comparison example is 45 MHz while that of the antenna device 1 as the embodiment example is 150 MHz, which means that the bandwidth in the embodiment example has been widened about three times in comparison with the comparison example.

Consequently, the invention can contribute to providing an antenna device that is small in its size but wide in its bandwidth.

1. An antenna device provided with a substrate and a radiation electrode which extends two-dimensionally and is formed on a surface of or inside said substrate, characterized in that said substrate has a hollow part or a recess.

2. An antenna device as claimed in claim 1, said substrate contains a dielectric material or a magnetic material.

3. An antenna device as claimed in claim 1 or 2, characterized in that a recess extending from a front surface of said substrate to a rear surface of said substrate is formed in a lower surface of said substrate, in that first and second grounding electrodes are formed respectively on both sides of that portion of said lower surface of said substrate where said recess is formed, and in that an electrode is formed on one of said front surface and said rear surface of said substrate, said electrode connecting said radiation electrode to each of said first and second grounding electrodes.

4. A printed circuit board comprising the antenna device as claimed in any of the claims 1-3.

5. A mobile tv radio apparatus comprising the antenna device as claimed in any of the claims 1-3.
